(19) United States
(12) Patent Application Publication
(10) Pub. No.: US 2022/0335386 A1
(43) Pub. Date: Oct. 20, 2022

(54) METHOD AND SYSTEM FOR RECRUITING CANDIDATES

(71) Applicant: Angela Lynn HOOD, Austin, TX (US)

(72) Inventor: Angela Lynn HOOD, Austin, TX (US)

(21) Appl. No.: 17/698,120

(22) Filed: Mar. 18, 2022

Related U.S. Application Data
(63) Continuation-in-part of application No. 16/484,590, filed on Aug. 8, 2019, now abandoned.

(30) Foreign Application Priority Data
Feb. 13, 2017 (GB) 1702350.8

(51) Int. Cl. G06Q 10/10

(52) U.S. Cl. CPC G06Q 10/1053

(57) ABSTRACT

Disclosed is a method for identifying at least one job opening provided by at least one recruiter company and presenting the at least one job opening to at least one job seeker, the method comprising: identifying the at least one job seeker; creating a database profile associated with the identified at least one job seeker based on a previous work history thereof; identifying the at least one recruiter company; identifying the at least one job opening associated with the at least one recruiter company; implementing a recommendation algorithm to match the at least one job seeker to the at least one job opening; and recommending the at least one job opening in real time to the at least one job seeker when the at least one job seeker uses an Augmented Reality (AR) enabled-device to receive information about the at least one job opening.

### TECHNICAL FIELD

The present disclosure relates generally to job searching services, and more particularly to a system and a method for mapping and displaying at least one job opening provided by at least one recruiter company using augmented reality (AR) technology.

### BACKGROUND

In recent years, AR has emerged as the next generation technology applied to enhance user experience in virtual reality. In principle, AR technologies aim to blend data or information stored on a data storage server with images or perceptions of the real world. For example, using a computer or a mobile device, a user can overlap previously stored information with an image acquired (for example a photograph) resulting in the user perceiving additional features. Such features can be any stored information such as one or more other images, videos, text, sounds, etc.

The key function of AR is to enhance user perceptions of the real world. Therefore, any stored information must be blended with real world perceptions in an intelligent way. An intelligent blending of information and the real world perceptions may be achieved both by adding information to one or more perceptions as well as recognizing and removing features acquired in the real world. Examples could be to add in real time a tag (e.g. a price) to an image a user acquires with a mobile device (e.g. a car on the street) or to remove background noise from a public location with the help of a second device especially set for AR.

The availability of the 3-dimensional videos, virtual reality and AR technology enables a user to perform actions or processes with higher precision while eliminating drawbacks associated with inefficiencies inherent in traditional processes. Such actions or processes can be applied to, for example, the entertainment industry where a user of the AR could, for example, view the food served in a restaurant or hear the music played in a night club simply by looking at those locations through an AR-enabled device. A person with an interest of buying an automobile, could simply walk around a given street and, by looking through an AR-enabled device get all information he or she needs to buy a similar automobile, not least alternatives with a higher specification but lower price. In the above examples, a consumer would significantly decrease or even eliminate the drawbacks associated with traditional actions or processes. For example, the buyer of the automobile would be presented with the choice of buying a similar alternative at a better price or one with a closer match to specifications sought instantly or in a relatively short period. Therefore, the time and/or costs associated with the process of buying the automobile would significantly decrease while the precision of the product-buyer match (i.e. car buyer match with car sought at desired price and location) would significantly increase.

Currently, a key problem in the job seeking placement market is that less than 50% of the jobs available are advertised. Moreover, conventional methods available for job seekers tend to be on large job data banks and online platforms which tend to lead to imprecise choices by the job seeker or recruiting party. However, available search tools either require the job seeker to go through a large number of search results or a search can return no results if the keywords defined by the job seeker are too unique or narrow.

Accordingly, there is a need to provide a profile matching tool that more intelligently matches the job description, accurately matches the skills and trails of job seeker to the skill set required by the recruiter and recommends the job opening to the job seeker.

In light of the foregoing discussion, there exists a particular opportunity to significantly improve drawbacks associated with conventional techniques and processes used by a job seeker to find a job matching their expectations and also meet the expectations of the employer.

### SUMMARY

The present disclosure seeks to provide a method for enhancing the experience of a job seeker when seeking a job. Moreover, the present disclosure seeks to provide at least one job opening provided by at least one recruiter company to a job seeker.

In an aspect, an embodiment of the present disclosure provides a method for identifying at least one job opening provided by at least one recruiter company and presenting the at least one job opening to at least one job seeker, the method comprising:
(i) identifying the at least one job seeker;
(ii) creating a database profile associated with the identified at least one job seeker based on a previous work history of the identified at least one job seeker;
(iii) identifying the at least one recruiter company;
(iv) identifying the at least one job opening associated with the at least one recruiter company;
(v) implementing a recommendation algorithm to match the at least one job seeker to the at least one job opening; and
(vi) recommending the at least one job opening in real time to the at least one job seeker when the at least one job seeker uses an Augmented Reality (AR) enabled-device to receive information about the at least one job opening, wherein the AR enabled device is configured to present the information about the job opening at a particular location, a pre-view and an insight of internal condition of the location,
   implementing the recommendation algorithm to compare personal and professional traits of the job seeker to desired traits of the recruiter company for the at least one job opening, wherein the method is configured to filter skills and traits in a profile of the job seeker and remove the similar skills and traits written in a different manner, and
   placing the at least one job opening data on a map and making the received information available by the AR enabled device,
   wherein identifying the at least one job opening comprises identifying the at least one job opening at a particular location at a particular timing by matching location, position, and job title, and
   wherein the identification of the at least one job opening occurs with different levels of confidence with respect to timing.

Optionally, the at least one job seeker is a person actively or inactively aiming to find a job. Optionally, identifying the at least one job seeker comprises receiving information from the at least one job seeker, and/or harvesting relevant information about the at least one job seeker from a computer network.

Optionally, identifying the at least one recruiter company comprises receiving information from the at least one recruiter company and/or by harvesting relevant information about the at least one job seeker from a computer network.

Optionally, creating the database profile associated with the at least one job seeker comprises receiving information from the at least one job seeker, and/or harvesting relevant information about the at least one job seeker from a computer network.

Optionally, identifying the at least one job opening comprises receiving information from the at least one recruiter company and/or identifying at least one potential job opening by receiving information from a person employed by an employer or from the employer that the employment of the person will be terminating the employment at a future date.

Optionally, recommending the at least one job opening to the at least one job seeker comprises presenting the information via an intelligent blend of the information related to: the job opening, the recruiter company or any other relevant information with one or more real world images acquired by the user of the AR enabled device.

Optionally, the method further comprises storing the information required for identifying: the at least one job seeker, the at least one recruiter company and/or identifying the at least one job opening.

Optionally, the method further comprises using a portable communication device as an AR enabled device. More optionally, the method further comprises using a lens adapted to the portable communication device for enabling AR technology at the portable communication device.

In another aspect, an embodiment of the present disclosure provides a system for identifying at least one job opening provided by at least one recruiter company and presenting the at least one job opening to at least one job seeker, the system comprising: a server, a user device associated with the at least one job seeker and a recruiter device associated with the at least one recruiter company, wherein the server, the user device and the recruiter device are connected via a communication network, the system comprising:

(i) a first identifying module arranged to identify the at least one job seeker;
(ii) a first implementation module arranged to implement a digital concierge for creating a database profile associated with the identified at least one job seeker based on a previous work history of the identified at least one job seeker;
(iii) a second identifying module arranged to identify at least one recruiter company;
(iv) a third identifying module arranged to identify the at least one job opening associated with the at least one recruiter company;
(v) a second implementation module arranged to implement a recommendation algorithm to match the at least one job seeker to the at least one job opening; and
(vi) a recommendation module arranged to recommend the at least one job opening in real time to the at least one job seeker when the at least one job seeker uses an Augmented Reality (AR) enabled device to receive information about the at least one job opening, wherein the AR enabled device is configured to present the information about the job opening at a particular location, a pre-view and an insight of internal condition of the location,
implementing the recommendation algorithm comprises comparing personal and professional traits of the job seeker to desired traits of the recruiter company for the at least one job opening, wherein the system is configured to filter skills and traits in a profile of the job seeker and remove the similar skills and traits written in a different manner, and
placing the job opening data on a map and making the received information available by the AR enabled device,
wherein identifying the job opening comprises identifying the job opening at a particular location at a particular timing by matching location, position, and job title, and
wherein the identification of the job opening occurs with different level of confidence with respect to timing.

Optionally, the job seeker is a person actively or inactively aiming to find a job.

Optionally, the first identifying module for identifying the at least one job seeker is operable for receiving information from the at least one job seeker, and/or harvesting relevant information about the job seeker from a computer network.

Optionally, the first implementation module arranged to implement the digital concierge for creating the database profile associated with the at least one job seeker comprises receiving information from the at least one job seeker, and/or harvesting relevant information about the at least one job seeker from a computer network.

Optionally, the second identifying module for identifying the at least one recruiter company is operable for receiving information from the at least one recruiter company and/or by harvesting relevant information about the at least one job seeker from a computer network.

Optionally, the third identifying module for identifying the at least one job opening is operable for receiving information from the at least one recruiter company and/or identifying at least one potential job opening by receiving information from a person employed by an employer or from the employer that the employment of the person will be terminating the employment at a future date.

Optionally, the recommendation module is operable for presenting the information via an intelligent blend of the information related to: the job opening, the recruiter company or any other relevant information with one or more real world images acquired by the user of the AR enabled device.

Optionally, the system further comprises a database for storing the information required for identifying: the at least one job seeker, the at least one recruiter company and/or identifying the at least one job opening.

Optionally, the system is further operable for using a portable communication device as an AR enabled device. More optionally, the system is further operable for using a lens adapted to the portable communication device for enabling AR technology at the portable communication device.

Embodiments of the present disclosure substantially eliminate or at least partially address the aforementioned problems in the prior art, and provide an efficient method and system for identifying at least one job opening provided by at least one recruiter company and presenting the at least one job opening to at least one job seeker. Advantageously, the job seeker being able to view jobs available in real time, at a particular building, house or location, including, where available, a pre-view and insight of internal conditions.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a detailed illustration of steps of the method for identifying at least one job opening provided by at least one recruiter company and presenting the at least one job opening to at least one job seeker, in accordance with various embodiments of the present disclosure; and

FIG. 2 is a schematic illustration of a system for identifying at least one job opening provided by at least one recruiter company and presenting the at least one job opening to at least one job seeker, in accordance with various embodiments of the present disclosure.

### DETAILED DESCRIPTION

The description of embodiments of the present disclosure is not intended to limit the scope of claims of the present disclosure. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Functional units described in this disclosure have been labelled as systems, modules or devices. A module, a device, or a system may be implemented in programmable hardware devices such as, processors, digital signal processors, central processing units, field programmable gate arrays, programmable array logic, programmable logic devices, cloud processing systems, or the like. The systems/devices/modules may also be implemented in software for execution by various types of processors. An identified system/device/module may comprise executable code and may, for example, comprise one or more physical or logical blocks of computer instructions, which may be, for example, organized as an object, procedure, function, or other construct. Nevertheless, the execution of an identified system/device/module need not be physically located together, but may comprise disparate instructions stored in different locations which, when joined logically together, comprise the system/device/module and achieve the stated purpose of the system/device/module.

Indeed, an executable code of a system/device/module could be a single instruction, or many instructions, and may even be distributed over several different code segments, among different applications, and across several memory system/device/module. Similarly, operational data may be identified and illustrated herein within the system/device/module, and may be embodied in any suitable form and organized within any suitable type of data structure. The operational data may be collected as a single data set, or may be distributed over different locations including over different storage devices, and may exist, at least partially, as electronic signals on a system/device/module or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

It will be appreciated that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

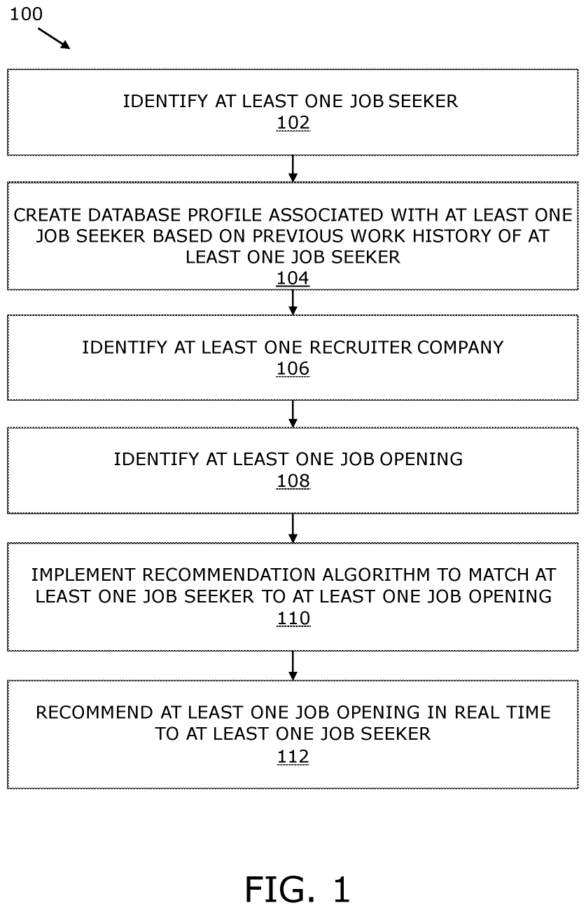

In FIG. 1 illustrated are steps of a method 100 for identifying at least one job opening provided by at least one recruiter company and presenting the at least one job opening to at least one job seeker, in accordance with an embodiment of the present disclosure.

At step 102 at least one job seeker is identified; at step 104 a database profile associated with the at least one job seeker based on a previous work history of the at least one job seeker is created; at step 106 at least one recruiter company is identified; at step 108 at least one job opening is identified; at step 110 a recommendation algorithm is implemented to match the at least one job seeker to the at least one job opening; and at step 112 the at least one job opening is recommended to the matched at least one job seeker on real time basis when the at least one job seeker is using an AR enabled-device to receive information about the at least one job opening.

Herein, the AR enabled device is configured to present the information about the job opening at a particular location, a pre-view and an insight of internal condition of the location. Moreover, the method comprises implementing the recommendation algorithm to compare personal and professional traits of the job seeker to the desired traits of the recruiter company for the at least one job opening, wherein the method is configured to filter skills and traits in a profile of the job seeker and remove the similar skills and traits written in a different manner. In an embodiment, the similar skills and traits written in a different manner may be identified and removed by using natural language processing. In an embodiment, the similar skills and traits written in a different manner may be identified and removed by using artificial intelligence and/or machine learning software. Furthermore, the method comprises placing the job opening data on a map and making the received information available by the AR enabled device. Herein, identifying the job opening comprises identifying the job opening at a particular location at a particular timing by matching location, position, and job title, and wherein the identification of job opening occurs with different level of confidence with respect to timing.

In an embodiment, the at least one job seeker may be a person actively aiming to find out a job. In another embodiment, the at least one job seeker may be a person inactively aiming to find out a job.

In an embodiment, identifying the at least one job seeker may comprise receiving information from the at least one job seeker, and/or harvesting relevant information about the at least one job seeker from a computer network.

In another embodiment, creating the database profile associated to the at least one job seeker may comprise receiving information from the at least one job seeker, and/or harvesting relevant information about the at least one job seeker from a computer network. Herein, the “database profile” refers to profiling of the previous work history associated with the at least one job seeker to be stored in a database. Notably, the “previous work history” may comprise of all the records and numerical data that is related to the work that has been done by the at least one job seeker during their tenure with a previous employer(s) or organization(s).

In an implementation, if the at least one job seeker is a scientist, then the database profile for the scientist may comprise of the numerical data, records and results of all experiments conducted by the scientist in past during their tenure with the previous employer(s) or the organization(s). Subsequently, in an implementation, the database profile may be used by the at least one job seeker to automate their work in their future jobs by utilizing the previous data stored in their database profile.

In an alternative implementation, the database profile may be used by the previous employer or organization of the at least job seeker to automate the future work that is to be done in their organization in the absence of the at least one job seeker by utilizing the previous data stored in the database profile. Beneficially, having such access to a previous data allows the said previous employer or organization to hire a resource that is lower in experience (or expertise) and/or on a reduced salary. In another embodiment, identifying the at least one recruiter company may comprise receiving information from the at least one recruiter company and/or by harvesting relevant information about the at least one job seeker from a computer network.

In another embodiment, the recruiter company may be identified by receiving and storing information of various companies looking to hire desirable candidates.

In yet another embodiment, the recruiter company may be identified by receiving and storing information of various companies in which the at least one job seeker may be applying for the at least one job opening.

Notably, the computer network may be a social media website or a personal or official website comprising information associated with the at least one job seeker and/or at least one recruiter company.

In yet another embodiment, identifying the at least one job opening may comprise receiving information from the at least one recruiter company and/or identifying at least one potential job opening by receiving information from a person employed by an employer or from the employer that the employment of the person will be terminating the employment at a future date. It will be appreciated that the future date may be a date from when a vacancy for the desired job opening will be effective.

In an embodiment, the at least on job opening may be identified by receiving and storing information of the companies having openings for a job position.

In yet another embodiment, identifying the at least one job opening may comprise receiving information from a person employed by an employer or from the employer that the employment of the person will be terminating the employment at a future date.

Optionally, an improved interface may be provided between the at least one job seeker and the recruiter company to identify desired traits in at least one job seeker for the at least one job opening. In this regard, a digital concierge is employed to allow the at least one job seeker to interact with the recruiter company using natural language and/or providing information in a text/audio/video form. In this regard, the digital concierge may use an artificial intelligence (AI) based device (discussed later) configured to interpret the at least one job seeker inputs, operationalize the at least one job seeker's intent into tasks and, execute the tasks to find relevant results.

In an embodiment, identification of the at least one job opening may comprise, but is not limited to the traditional methods of identifying a job opening, such as data harvested from third party databases as well as data directly input by candidates. In this embodiment, the data harvested from third party databases may comprise the information such as location, place of work, office, company type, job function, testimony from others, social media traits and so forth.

In an embodiment, recommending the at least one job opening in real time to the at least one job seeker may comprise presenting the information via an intelligent blend of the information related to: the job opening, the recruiter company or any other relevant information with one or more real world images acquired by the user of the AR enabled device. It will be appreciated that said intelligent blend of information increases chances of identifying suitable job openings to match with the requirements of the at least one job seeker as well as the at least recruiter company. Moreover, said intelligent blend of information also increases a likelihood of hiring for said job opening.

In an embodiment, recommending the at least one job seeker to the at least one job opening may comprise comparing personal and professional traits of the job seeker to the desired traits of the recruiter company for the at least one job opening.

In yet another embodiment, the method 100 may further comprise using a portable communication device as an AR enabled device. In this embodiment, the method 100 may further comprise using a lens adapted to the portable communication device for enabling AR technology at the portable communication device. Moreover, the AR enabled device enables the at least one job seeker to find the location of the at least one recruiter company on a map. In this regard, the AR enabled device enables the at least one job seeker to pre-view the interior view of the at least one recruiter company. Furthermore, optionally, when the at least one job seeker reaches near (or at) the location of the at least one recruiter company, the AR enabled device provides the advertisement of the at least one job opening displaying the information regarding the at least one job opening on the AR enabled device. It will be appreciated that the AR enabled device also display the AR images of the at least one recruiter company. In this regard, the user of the AR enabled device, such as the at least one job seeker, has access to the real-time condition of the recruiter company's infrastructure, location and a market presence.

In another embodiment, the method 100 may further comprise storing the information required for identifying: the at least one job seeker, the at least one recruiter company and/or identifying the at least one job opening. It will be appreciated that in case of storing the at least one job opening, such database maintenance may assist the human resource manager or similar authorised personnel to create a similar job opening in future. However, in case of the at least one job seeker and/or at least one recruiter company, any other recruiter company or job seeker may refer (or list) back to the said at least one job seeker and/or at least one recruiter company in future.

In an exemplary embodiment, the at least one job seeker may be a job seeker actively or inactively seeking employment. Here, actively looking for employment has the meaning of a person searching of a job through the various currently available methods. Meanwhile, a person inactively looking for employment has a meaning of a person performing actions or disclosing information that could indirectly lead to the need of that person to seek employment—for example, a notification by the person to his or her employer or a notification form an employer to the person that employment will be terminated at a particular date. The recruiter company may be an organization having at least one job opening and is willing to hire candidates (such as the job seeker). Alternatively, the recruiter company may be a job consultancy company associated with at least one organization providing the at least one job opening to the candidate (such as the job seeker).

The term “passport” or “professional passport” refers to skills desired by the recruiter company which are identified in the candidate work related information by the recruiter company. In an embodiment, the professional passport is an online dynamic document that is updated directly by the recruiter company and the job matching system (for example, via a learning algorithm, described herein later).

In another embodiment, identifying or predicting a job opening may comprise identifying the job opening at a particular location and at a particular time by matching the location, position, job title and all relevant information of a currently employed candidate who starts the process of searching for a new job, by inputting data on job searching platforms, contacting recruiters or exhibiting particular behaviors.

In another embodiment, prediction of a job opening may occur with different levels of confidence, especially with respect to timing. For example—100% confidence occurs when a candidate is employed in employer A, but signs a contract with Employer B to start on a particular date.

In an embodiment, the recommendation algorithm may match and place job opening data on a map, including all available tags (to increase matching confidence) and make this information available to AR enabled devices, for example, the user device. Optionally, the user device may be an AR enabled device. Optionally, the user device may be a mobile phone.

In an embodiment, the at least one job opening may be associated with any field of work but not limited to, sales, engineering, marketing, software developing, accounting, medicine, hospitality, aviation, cooking, fashion designing, law and security services.

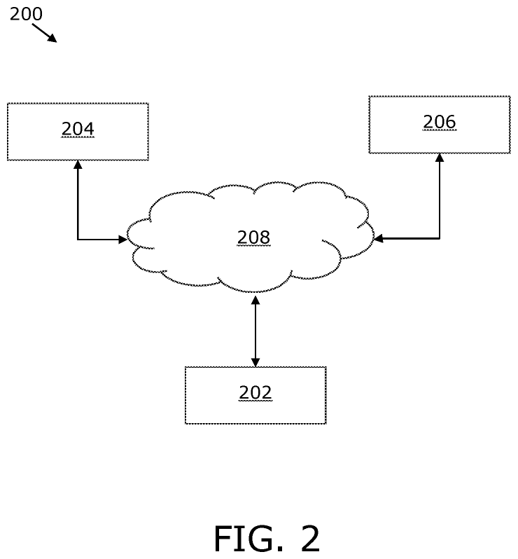

In FIG. 2 illustrated is a schematic illustration of a system 200 arranged to identify at least one job opening provided by at least one recruiter company and presenting the at least one job opening to at least one job seeker, in accordance with various embodiments. The system 200 comprises a server 202, a user device 204 associated with the at least one job seeker, and a recruiter device 206 associated with the at least one recruiter company, wherein the server 202, the user device 204 and the recruiter device 206 are connected via a communication network 208.

The system 200 comprises a first identifying module for identifying the at least one job seeker, a first implementation module for implementing a digital concierge for creating a database profile associated with the at least one job seeker based on a previous work history of the at least one job seeker, a second identifying module for identifying the at least one recruiter company, a third identifying module for identifying the at least one job opening associated with the at least one recruiter company, a second implementation module for implementing a recommendation algorithm to match the at least one job seeker to the at least one job opening; and a recommendation module to recommend the at least one job opening in real time to the at least one job seeker when the at least one job seeker uses an AR enabled device to receive information about the at least one job opening.

Moreover, the AR enabled device is configured to present the information about the job opening at a particular location, a pre-view and an insight of internal condition of the location. The system 200 comprises implementing the recommendation algorithm and comprises comparing personal and professional traits of the job seeker to the desired traits of the recruiter company for the at least one job opening. The system 200 is configured to filter skills and traits in a profile of the job seeker and remove the similar skills and traits written in a different manner, and placing the job opening data on a map and making the received information available by AR enabled device. Additionally, identifying the job opening comprises identifying the job opening at a particular location at a particular timing by matching location, position, and job title, and wherein the identification of job opening occurs with different level of confidence with respect to timing.

In an embodiment, the user devices 204 and recruiter device 206 may comprise cell phones, phablet computers, tablet computers, desktop computers, personal digital concierges (PDA), and so forth. A typical example of the devices 204 and 206 is a wireless data access-enabled device, for example, an iPHONE® smart phone, a BLACKBERRY® smart phone, a NEXUS ONE™ smart phone, an iPAD® device, and so forth, that is capable of sending and receiving data in a wireless manner using protocols like the internet protocol (IP), and the wireless application protocol (WAP).

In an embodiment, the communication network 208 may be wired, wireless or a combination thereof. According to an embodiment, the communication network 208 comprises, but is not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAx) networks.

The system 200 is operable to receive information describing the at least one job opening by the recruiter company. The information describing the at least one job opening comprises job description, desired traits and skills in candidate, namely, the at least one job seeker.

In an embodiment, the identifying module for identifying the at least one job seeker may be operable for receiving information from the at least one job seeker, and/or harvesting relevant information about the job seeker from a computer network.

Herein, the term “digital concierge” refers to a high level advanced computer program that enables communication and interaction between the server 202 and the user device 204 at least one job seeker via the communication network 208, wherein the digital concierge is configured to receive the previous work history related to the database profile associated to the at least one job seeker, where the data may be received in the form of audio inputs from the at least one job seeker, thus the digital concierge plays the role of simulating a real life communication with the at least one job seeker to receive the previous work history. Subsequently, based on the received previous work history, the digital concierge is configured to create the database profile at the backend for the at least one job seeker for viewing of said digital profile. Moreover, the digital concierge is configured to analyze the previous work history stored in the database profile and enable the automation of the work future work that is to be done by the at least one job seeker.

Alternatively, the analyzed previous work history of the at least one job seeker can also be accessed by the previous employer or organization of the at least one job seeker to automate the future work at their respective organization in the absence of the at least one job seeker.

In an embodiment, the first implementation module for implementing the digital concierge for creating the database profile associated to the at least one job seeker comprises receiving information from the at least one job seeker, and/or harvesting relevant information about the at least one job seeker from a computer network.

In another embodiment, the second identifying module for identifying the at least one recruiter company may be operable for receiving information from the at least one recruiter company and/or by harvesting relevant information about the at least one job seeker from a computer network.

In another embodiment, the third identifying module for identifying the at least one job opening may be operable for receiving information from the at least one recruiter company and/or identifying at least one potential job opening by receiving information from a person employed by an employer or from the employer that the employment of the person will be terminating the employment at a future date.

In yet another embodiment, the recommendation module may be operable for presenting the information via an intelligent blend of the information related to: the job opening, the recruiter company or any other relevant information with one or more real world images acquired by the user of the AR enabled device.

In another embodiment, the system 200 may further comprise a database for storing the information required for identifying: the at least one job seeker, the at least one recruiter company and/or identifying the at least one job opening.

In yet another embodiment, the system 200 may further comprise using a portable communication device as an AR enabled device. In this embodiment, the system 200 may further comprise using a lens adapted to the portable communication device for enabling AR technology at the portable communication device.

The present disclosure provides a method and a system of mapping at least one job opening provided by at least one recruiter company to candidate profiles. The disclosed method and system are beneficial in terms of the job seeker being able to view jobs available in real time, at a particular building, house or location, including, where available, a pre-view and insight of internal conditions, increase job satisfaction, average time on a job, and personal satisfaction. In addition, the disclosed method and system determines desired traits for a job opening in the recruiter company, such as personality characteristics, personal features such as being creative and so forth. The disclosed method and system further take into consideration these traits while finding the candidates for the job opening. Furthermore, the disclosed method and system ranks the profiles of the candidates to a job opening, and then recommends the high ranked candidate profiles to a job opening. Further, the disclosed method and system provide a more intelligent and accurate tool to the recruiters as it is capable of filtering the skills and traits in candidate profiles and removing the similar skills and traits written in a different manner. Additionally, the disclosed method and system employ an AI-based digital concierge for recording a work done by the at least one job seeker in a current organization or one or more previous organizations.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

1. A method for identifying at least one job opening provided by at least one recruiter company and presenting the at least one job opening to at least one job seeker, the method comprising:
(i) identifying the at least one job seeker;
(ii) creating a database profile associated with the identified at least one job seeker based on a previous work history of the identified at least one job seeker;
(iii) identifying the at least one recruiter company;
(iv) identifying the at least one job opening associated with the at least one recruiter company;
(v) implementing a recommendation algorithm to match the at least one job seeker to the at least one job opening; and
(vi) recommending the at least one job opening in real time to the at least one job seeker when the at least one job seeker uses an Augmented Reality (AR) enabled device to receive information about the at least one job opening, wherein the AR enabled device is configured to present information about the job opening at a particular location, a pre-view and an insight of internal condition of the location,
implementing the recommendation algorithm to compare personal and professional traits of the job seeker to the desired traits of the recruiter company for the at least one job opening, wherein the method is configured to filter skills and traits in a profile of the job seeker and remove the similar skills and traits written in a different manner, and
placing the job opening data on a map and making the received information available by the AR enabled device,
wherein identifying the at least one job opening comprises identifying the at least one job opening at a particular location at a particular timing by matching location, position, and job title, and
wherein the identification of the at least one job opening occurs with different levels of confidence with respect to timing.

2. The method according to claim 1, wherein the at least one job seeker is a person actively or inactively aiming to find a job.

3. The method according to claim 1, wherein identifying the at least one job seeker comprises receiving information from the at least one job seeker, and/or harvesting relevant information about the at least one job seeker from a computer network.

4. The method according to claim 1, wherein creating the database profile associated with the at least one job seeker comprises receiving information from the at least one job seeker, and/or harvesting relevant information about the at least one job seeker from a computer network.

5. The method according to claim 1, wherein identifying the at least one recruiter company comprises receiving information from the at least one recruiter company and/or harvesting relevant information about the at least one job seeker from a computer network.

6. The method according to claim 1, wherein identifying the at least one job opening comprises receiving information from the at least one recruiter company and/or identifying at least one potential job opening by receiving information from a person employed by an employer or from the employer that the employment of the person will be terminating the employment at a future date.

6. The method according to claim 1, the method further comprises storing the information required for identifying: the at least one job seeker, the at least one recruiter company and/or identifying the at least one job opening.

7. The method according to claim 1, the method further comprises using a portable communication device as an AR enabled device.

8. The method according to claim 7, the method further comprises using a lens adapted to the portable communication device for enabling AR technology at the portable communication device.

9. A system arranged to identify at least one job opening provided by at least one recruiter company and present the at least one job opening to at least one job seeker, the system comprising: a server, a user device associated with the at least one job seeker and a recruiter device associated with the at least one recruiter company, wherein the server, the user device and the recruiter device are connected via a communication network, the system comprising:
(i) a first identifying module arranged to identify the at least one job seeker;
(ii) a first implementation module arranged to implement a digital concierge for creating a database profile associated with the identified at least one job seeker based on a previous work history of the identified at least one job seeker;
(iii) a second identifying module arranged to identify at least one recruiter company;
(iv) a third identifying module arranged to identify the at least one job opening associated with the at least one recruiter company;
(v) a second implementation module arranged to implement a recommendation algorithm to match the at least one job seeker to the at least one job opening; and
(vi) a recommendation module arranged to recommend the at least one job opening in real time to the at least one job seeker when the at least one job seeker uses an AR enabled device to receive information about the at least one job opening, wherein the AR enabled device is configured to present the information about the job opening at a particular location, a pre-view and an insight of internal condition of the location,
implementing the recommendation algorithm comprises comparing personal and professional traits of the job seeker to desired traits of the recruiter company for the at least one job opening, wherein the system is configured to filter skills and traits in a profile of the job seeker and remove the similar skills and traits written in a different manner, and
placing the at least one job opening data on a map and making the received information available by an AR enabled device,
wherein identifying the at least one job opening comprises identifying the at least one job opening at a particular location at a particular timing by matching location, position, and job title, and
wherein the identification of job opening occurs with different level of confidence with respect to timing.

10. The system according to claim 9, wherein the job seeker is a person actively or inactively aiming to find a job.

11. The system according to claim 9, wherein the first identifying module for identifying the at least one job seeker is operable for receiving information from the at least one job seeker, and/or harvesting relevant information about the job seeker from a computer network.

12. The system according to claim 9, wherein the first implementation module is arranged to implement the digital concierge for creating the database profile associated with the at least one job seeker comprises receiving information from the at least one job seeker, and/or harvesting relevant information about the at least one job seeker from a computer network.

13. The system according to claim 9, wherein the second identifying module for identifying the at least one recruiter company is operable for receiving information from the at least one recruiter company and/or by harvesting relevant information about the at least one job seeker from a computer network.

14. The system according to claim 9, wherein the third identifying module for identifying the at least one job opening is operable for receiving information from the at least one recruiter company and/or identifying at least one potential job opening by receiving information from a person employed by an employer or from the employer that the employment of the person will be terminating the employment at a future date.

15. The system according to claim 9, wherein the system further comprises a database for storing the information required for identifying: the at least one job seeker, the at least one recruiter company and/or identifying the at least one job opening.

16. The system according to claim 9, wherein the system is further operable for using a portable communication device as an AR enabled device.

17. The system according to claim 16, wherein the system is further operable for using a lens adapted to the portable communication device for enabling AR technology at the portable communication device.
